(19) United States
(12) Patent Application Publication
(10) Pub. No.: US 2008/0266080 A1
(43) Pub. Date: Oct. 30, 2008

(54) Wireless communication system

(76) Inventors: Wing Fai Leung, Wanchai (HK); Po Fong Cheng, Wanchai (HK)

Correspondence Address: James A. Gavney Jr.;JAG Patent Services, Suite 21, 1901 Old Middlefield Way, Mountain View, CA, 94043, US

(21) Appl. No.: 12/148,490

(22) Filed: Apr. 18, 2008

Related U.S. Application Data
(60) Provisional application No. 60/927,116, filed on Apr. 30, 2007.

(51) Int. Cl. H04Q 7/00

(52) U.S. Cl. 340/539.16

(57) ABSTRACT

A wireless system for controlling electrical circuits within a building is disclosed. The system includes a plurality of monitor devices coupled to load circuits and configured to control the load circuits. The system also includes a master control device configured to remotely communicate with the monitor devices. The system is configured to manually or remotely control the load circuits based on input commands input from the monitor device or the master control device and/or media data captured or acquired from the monitor devices and/or the master control device. Preferably, the monitor devices includes an image capture unit and transmit images to the master control device. The monitor devices also preferably include a motion sensor for detecting motion in locations corresponding the monitor devices and controlling the load circuits based on the motion detected. The system operates as a lighting control system and a security system.

### RELATED APPLICATION

This patent application claims priority under 35 U.S.C. 119 (e) of the U.S. Provisional Patent Application Ser. No. 60/927,116, filed Apr. 30, 2007, and titled “WIRELESS COMMUNICATION SYSTEM”. The U.S. Provisional Patent Application Ser. No. 60/927,116, filed Apr. 30, 2007, and titled “WIRELESS COMMUNICATION SYSTEM” is hereby incorporated by reference.

### FIELD OF THE INVENTION

This invention relates to wireless communication systems. More specifically, this invention relates to wireless audio and/or video systems for transmitting media data between locations corresponding to wireless devices and controlling load circuits therefrom.

### BACKGROUND

Wireless networks can be used to transmit information from one location to another location and or to broadcast information from one location to multiple location. Information that is transmitted over a wireless network can include configuration and execution data, text, voice and video data, the temperature and humidity readings at the perspective locations. Wireless networks have continued to develop and applications have significantly grown as faster transmissions of larger quantities of data are now possible.

Wireless networks provide number of advantages over hard-wire networks. Wireless networks allow you to eliminate messy cables. Wireless connections offer more mobility, the downside is there can sometimes be interference that might block the radio signals from passing through. One way to avoid this is by putting the source of your wireless connection in a place where the signal will have as little interference as possible. Sometimes nearby networks are using the same frequencies, this can also cause interference within the network and can reduce its performance.

Another problem with wireless networks is that they are more vulnerable to access from unwanted sources or “intruders.” Many networks offer WEP—Wired Equivalent Privacy—security systems which have been found to be vulnerable to intrusion. Though WEP does block some intruders, the security problems have caused some businesses to stick with wired networks until security can be improved. Another type of security for wireless networks is WPA—Wi-Fi Protected Access. WPA provides more security to wireless networks than a WEP security set up. The use of firewalls can also help to prevent security breaches.

While wireless communications and devices have greatly improved, hard-wire networks remain dominantly used for a number of applications, at least in part due to security and privacy issues described above.

### SUMMARY

The invention is directed to a wireless system that is used for communication, security, indoor and outdoor weather monitor controlling electrical circuits and lighting. The system is configured to be used in any building, but is preferably configured to be used for residential buildings. The system includes a plurality of devices. At least a portion of the devices are hardwired to the load circuits, referred to herein as monitor devices, and at least one of the devices, referred to herein as a master control device is a mobile remote control device. Preferably, all of the system devices, monitor devices and control devices, are configured to transmit media data between each other over a wireless peer-to-peer network, where by data is transmitted in radio packet form. However, it will be clear to one skilled in the art from the discussion below that the devices of the present invention can communicate or transmit data between each other using any suitable network method or protocol. For example, monitor devices can communicate or transmit data between each other through power lines, routers, cables and any other suitable network hardware. The media data that is communicated or transmitted between devices corresponds to sound and/or visual media data that is collected, captured or recorded from the devices at their respective locations. Preferably, control devices are used to control the monitor devices and/or the load circuits through the monitor devices remotely.

In accordance with the embodiments of the invention, the system includes a plurality of monitor devices. The monitor devices are electrically coupled to load circuits and are configured to control the load circuit either manually or remotely using the master control device, such as described below. Preferably, the monitor devices include power circuitry and wire leads for coupling to load circuits and providing power to the monitor devices. Alternatively, or in addition to being powered through the load circuits, the monitor devices include a battery for providing power or chargeable battery charged by solar cells or charged by the ac EM field chargers coupled to the load circuits.

The monitor devices, in accordance with the embodiments of the invention, include a sensor unit. The senor unit includes a temperature sensor, a humidity sensor, a smoke sensor, a gas sensor, any other suitable sensor or combination of sensors. The sensor collects environment data corresponding to the locations of the monitor devices and periodically transmits the environment data to the master control device. For example, the sensor unit is a temperature and humidity sensor that monitors weather conditions at the respective locations of the monitor devices. The weather conditions are captured and digitized periodically by an ADC circuit of the monitor devices and the monitor devices periodically and automatically transmit weather data packets with weather information to the master control device, where up-dated representation of the weather data is displayed on an LCD screen at the master control devices.

As mentioned above, the sensor unit alternatively to, or in addition to, a temperature and humidity sensor includes a smoke or gas sensor for detecting the smoke or a gas leak. Where smoke or a gas is detected by the sensor, the monitoring devices automatically transmit an alarm signal to the master control device and/or trigger an external alarm.

The monitor devices include a monitor media capture unit configured to capture monitor media data corresponding the locations of the monitor devices. The monitor media capture unit includes, for example, a microphone and/or a camera. Where the monitor media capture unit includes a camera, the camera is any suitable camera configured to take still images, streaming live video data or a combination thereof.

A camera of the monitor device is preferably capable of panning and or tilting through a range of capture angles for effectively capturing a range of still or video images. The pan and tilt camera motion of traditional servo-motor controlled mechanism can result in EMI radiation, motor and gear noise, which can reduce the quality of the RF transmission performance and AV quality of the wireless system of the present invention. Further servo-motor mechanical structures and circuit designs for a camera motion system are too large to be readily adapted to a faceplate housing structure, such as described below.

Accordingly, a monitor device of the present invention preferably includes a micro-camera module with and a magnetic motion control mechanism for controlling movement of a camera unit remotely from a master control device through a user interface, such as described in detail below.

The monitor devices also include a monitor wireless transducer unit for transmitting the monitor media data and receiving control media data from a master control device. The monitor devices further include a monitor microprocessor unit programmed with firmware and other circuitry, such as shown in FIG. 4A, for supporting the operation of the monitor devices.

In still further embodiments of the invention, the monitor devices include a monitor media output unit. The monitor output unit includes, for example, a speaker and/or a video screen to generate an audio and/or visual representation of the control media data received by the master control device.

The master control device also displays the temperature and humidity readings captured by the remote monitor device sensors at the respective locations.

The master control device includes a gas leakage alarm signal generator to respond to the gas leakage accident happening at the locations of the monitor devices. It automatically displays and identifies an environment image of the exact location happening gas leakage accident once the gas detector of monitor device is triggered.

The master control device includes a control media capture unit. The control media capture unit includes microphone and/or a camera, such as described above, or any other suitable components for capturing the control media data corresponding to a location of the master control device.

The master control device also includes a control wireless transducer unit configured to receive the monitor media data transmitted from each of the monitor devices and transmit the control media data to each of the monitor devices. The master control device also includes a microprocessor unit programmed with firmware and other circuitry, such as shown in FIG. 4B, for supporting the operation of the master control device.

The master control device also preferably includes a control media output unit. The control media output unit includes, for example, a speaker and/or a video screen to generate an audio and/or visual representation of the monitor media data transmitted to the master control device by each of the monitor devices.

In accordance with the embodiments of the invention, the master control device is configured to remotely control the load circuits through the plurality of monitor devices. In operation, the master control device can select any of the monitoring devices and play an audio or visual representation of the location corresponding to that of the selected monitor device. The monitor devices are selected by entering a code or dialing a number. The master control device is also configured to play an audio and/or visual representation of the locations of any number of the monitor devices simultaneously. While playing an audio and/or visual representation of one or more of the locations of any of the monitor devices, temperature and/or humidity readings corresponding to the one or more of the locations of any of the monitor devices can also be displayed on the master control device, through for example and LCD display.

In further embodiments of the invention, the monitor devices include a motion sensor unit. In accordance with this embodiment, the monitor devices are configured to control the load circuits based on motion detected by the motion sensor unit. The motion sensor unit includes an infrared motion sensor, an ultrasonic motion sensor or a combination thereof. In accordance with this embodiment, the system is capable of being placed into “Security Mode”. While the system is in Security Mode,” the monitor devices monitor rooms corresponding to their respective location. When motion is detected by one of the motion sensor units, the corresponding monitor device automatically collects or records monitor media data and transmits the monitor media data to the master control device. The monitor media data can then be played or displayed on the master control device and/or stored in the removable or permanent data storage unit, such as described below.

The system can also be configured to operate in a “Reminder Mode”. While the system is set in the “Reminder Mode” one or more of the monitor devices automatically recalls and displays or plays an audio and/or visual reminder message at the monitor devices, which has been previously recorded and stored in a memory storage unit of the master control device. In accordance with this embodiment of the invention, the monitor devices automatically recalls and displays or plays the audio and/or visual reminder message when the motion sensors of the respective monitor devices are triggered.

In a particular embodiment of the invention, the monitor devices includes a faceplate body configured to couple to and fit over a momentary switch that manually opens and closes a load circuit. Alternatively, the monitor devices are configured to couple to and fit into an electrical wall boxes and replace standard momentary light switches. In accordance with this embodiment, the monitor devices are configured to manually control the load circuits through a user interface, such as described below.

The monitor devices and/or the master control devices preferably include a user interface. The user interface includes, for example a key pad and/or a touch screen with an interactive on-screen user manual. The user interface is configured for operating and programming the master control device and/or the monitor devices as well as controlling the load circuits, such as described above. Alternatively, or in addition the user interface, the master control device and/or the monitor devices are configured to be operated or programmed using voice recognition software stored on their respective micro-processor units.

It will be clear to one skilled in the art from the discussions above and below that the control device and/or the monitor devices can also be configured to operate as cell phones, a PDAs or a desk top computers. Further, the system of the present invention can be networked to a central computer, a central server and/or be coupled to and operate an external alarm or security system.

### BRIEF DESCRIPTION OF DRAWINGS

FIG. 1A shows a building with a plurality of monitor devices configured to remotely transmit media data over a wireless network with a master control device, in accordance with the embodiments of the invention.

FIG. 1B shows a schematic representation of a wireless network for transmitting media data between system devices, in accordance with the embodiments of the present invention.

FIG. 2A illustrates a front view of a monitor device with a faceplate body configured to couple to and fit over a momentary light switch, in accordance with the embodiments of the present invention.

FIG. 2B illustrates a front view of a monitor device configured to couple to and fit into an electrical wall box, in accordance with the embodiments of the present invention.

FIG. 2C illustrates a side view of the monitor device shown in FIG. 2A.

FIG. 2D illustrates a side view of the monitor device shown in FIG. 2 B.

FIG. 3A illustrates a front view of the master control device, in accordance with the embodiments of the present invention.

FIG. 3B illustrates a side view of a master control device shown in FIG. 3A.

FIG. 4A shows a schematic representation of the electrical components for a monitor device, in accordance with the embodiments of the present invention.

FIG. 4B shows a schematic representation of the electrical components for a master control device, in accordance with the embodiments of the present invention.

FIG. 5 shows a schematic representation of the electrical components for a magnetic motion mechanism, in accordance with the embodiments of the present invention.

FIG. 6A-C show cross-sectional side views of the micro-camera module that is operated using a magnetic motion mechanism shown in FIG. 5.

### DETAILED DESCRIPTION

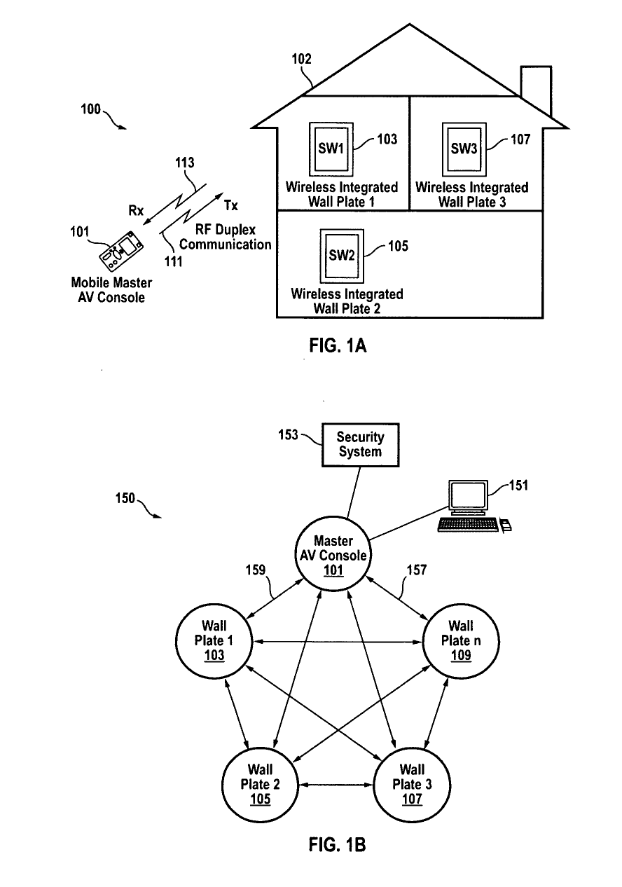

FIG. 1A shows a representation 100 of building 102 with a plurality of monitor devices 103, 105, 107 configured to remotely transmitting media data over a wireless network indicated by the arrows 111 and 113 with a master control device 101. Herein and throughout the specification the same reference numbers are used for similar elements.

FIG. 1B shows a schematic representation of the wireless network 150 for transmitting media data between system devices. The system devices include at least one master control device 101 and any number of monitor devices 103, 105, 107 and 109. The system devices 101, 103, 105, 107 and 109 are configured to transmit media data between each other in a wireless peer-to-peer and half/full duplex communication network as indicated by the arrows 157 and 159. The media data is preferably transmitted between the system devices 101, 103, 105, 107 and 109 in radio data packet form. The media data is transmitted between system devices 101, 103, 105, 107 and 109 using any suitable protocol. In alternative embodiments of the invention, the monitor devices 103, 105, 107 and 109 are configured to transmit media data between each other through power lines, routers, cables and any other suitable network hardware, while the master control device transmits and receives media data via the wireless network. Preferably, the monitor devices 103, 105, 107 and 109 are electrically coupled to load circuits that power lights and/or outlets. The monitor devices 103, 105, 107 and 109 are configured to control the load circuit manually from the monitor devices 103, 105, 107 and 109 and remotely from the master control device 101.

Still referring to FIG. 1B, the media data that is transmitted between system devices 101, 103, 105, 107 and 109 over the wireless network 150 corresponds to sound or visual media data that is collected, captured or recorded by the system devices 101, 103, 105, 107 and 109 at their respective locations. The system, in accordance with the embodiments of the invention, is networked to a central computer 151, a central server and/or is coupled to an external alarm or security system 153. In yet further embodiments of the invention the system devices 101, 103, 105, 107 and 109, or a portion thereof, are configured to operate as cell phones or personal data assistants (PDAs).

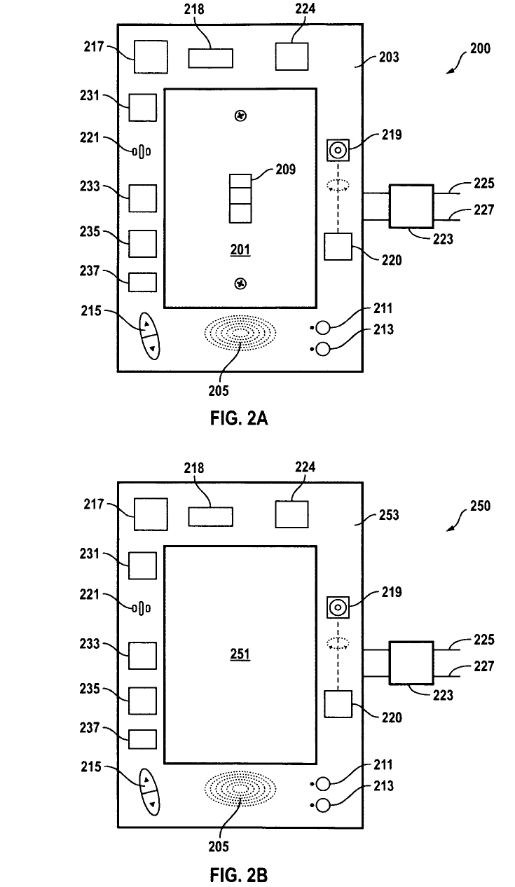

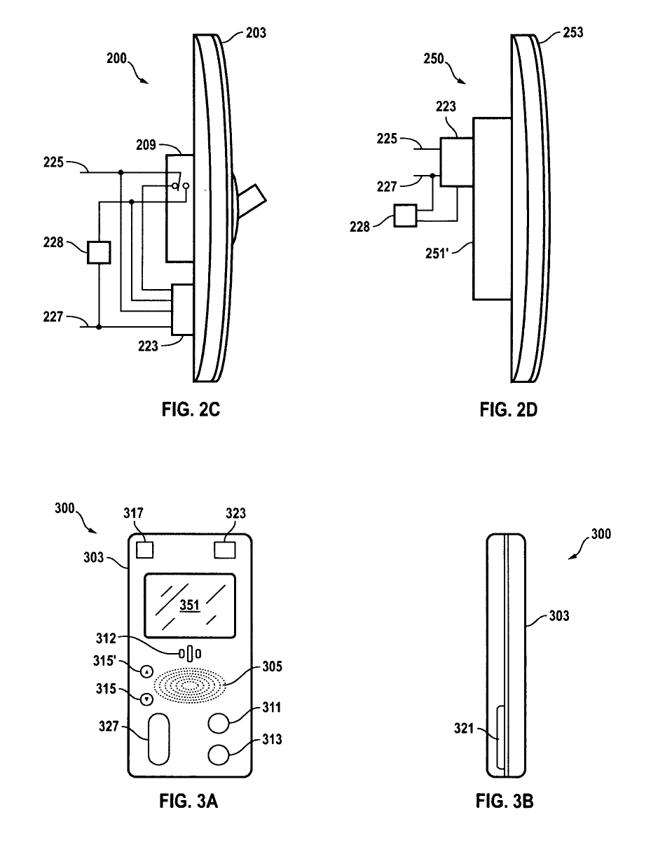

FIG. 2A illustrates a front view of a monitor device 200 with a faceplate body 203 configured to couple to and fit over a light switch 201 with a momentary switch 209 for manually operating a load circuit 228 (FIG. 2C). Preferably, the monitor device 200 includes power circuitry 223 and wire leads 225 and 227 for coupling to the load circuit and providing power to monitor device 200. Alternatively, or in addition to being powered through the load circuit, the monitor device 200 can include a battery such as solar cell with rechargeable battery and dry cell or EM field charger circuit with rechargeable battery 218 for providing power.

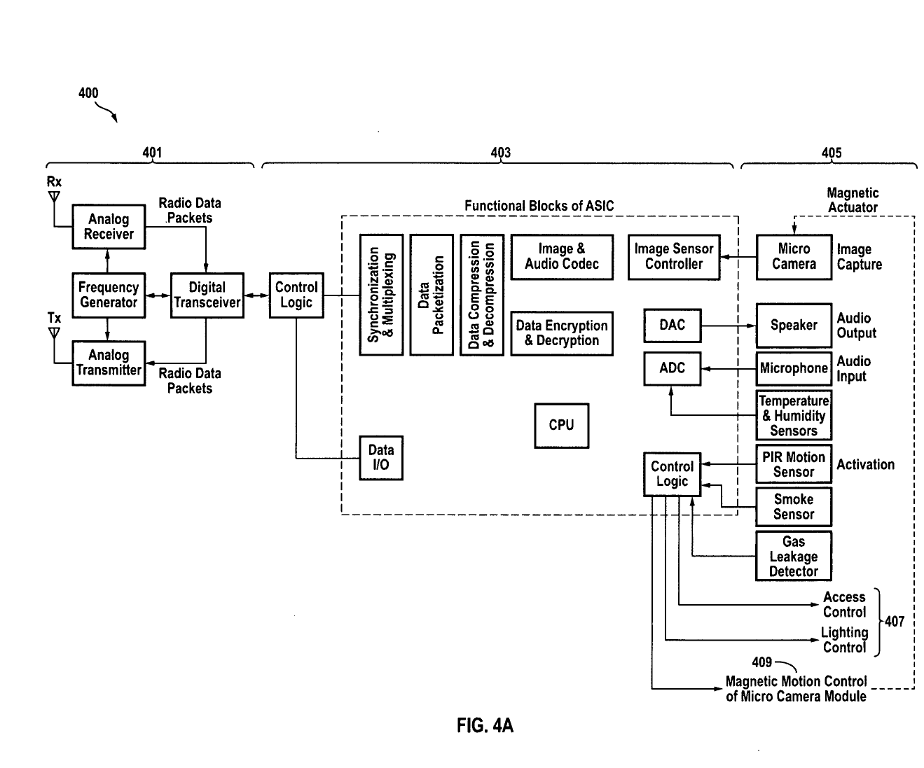

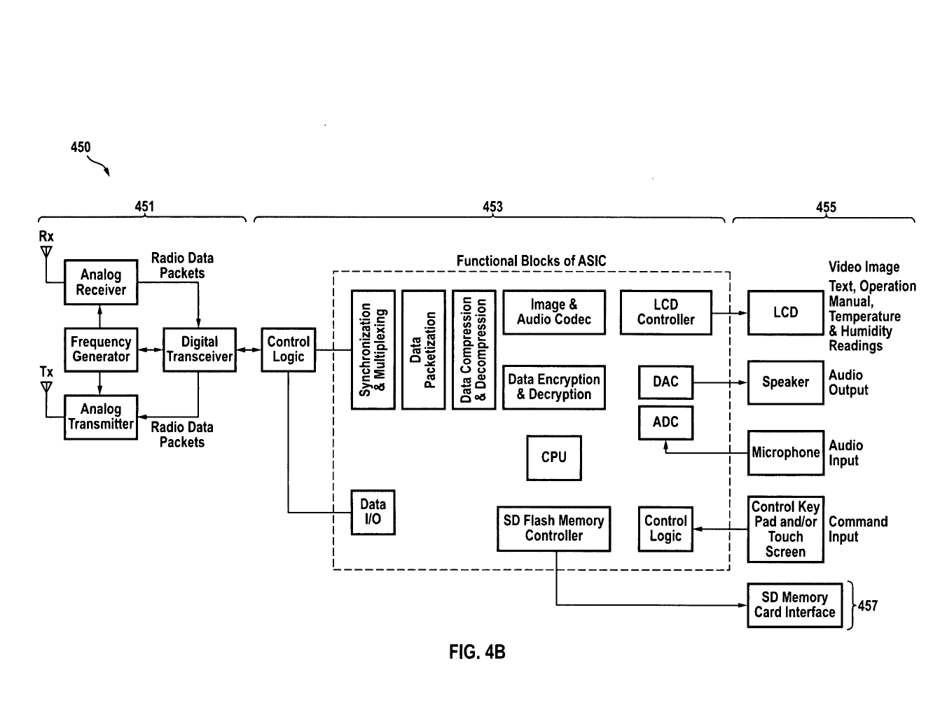

The monitor device 200 include a monitor media capture unit configured to capture monitor media data corresponding the locations of the monitor devices. The monitor media capture unit includes, for example, a microphone 221 and/or a camera 219 configured to take still images and/or stream live video data. The monitor device 200 also include a monitor wireless transducer unit with a transmitter 211 for transmitting monitor media data from the monitor device 200 to a master control device 300 (FIGS. 3A-B) and other monitoring devices within the system. The monitor wireless transducer unit also includes a receiver 213 for receiving control media data from the master control device 300 or monitor media data from other monitor devices within the system. The monitor device 200 further includes a monitor microprocessor unit 217 programmed with firmware and other circuitry for supporting the operation of the monitor device 200, such as described with reference to FIG. 4A.

Still referring to FIG. 2A, the monitor device 200 also preferably includes a monitor media output unit. The monitor output unit includes, for example, a speaker 205 for generating an audio representation of control media data received by the receiver 213 from the master control device 300 (FIGS. 3A-B) or monitor media data received from other monitor devices within the system.

FIG. 2B illustrates a front view a monitor device 250 configured to fit into an electrical wall box and electrically couple to a load circuit 228 (FIG. 2C) through power circuitry 223 and wire leads 225 and 227, such as described above. In accordance with this embodiments, the monitor device 250 includes a face plate body 253 and is configured to replace a momentary switch 201 (FIG. 2A) and is preferably configured to manually control the load circuit directly from monitor devices 250 and remotely control the load circuit from the master control devices 300 (FIGS. 3A-B).

Still referring to FIG. 2B, the monitor device 250 includes a monitor media capture unit that includes a microphone 221 and/or a camera 219, a monitor wireless transducer unit with a transmitter 211 for transmitting monitor media data from the monitor device 250 to a master control device 300 (FIGS. 3A-B) and other monitoring devices within the system. The monitor wireless transducer unit also includes a receiver 213 for receiving control media data from the master control device 300 or monitor media data from other monitor devices within the system. The monitor device 250 further includes a monitor microprocessor unit 217 programmed with firmware and other circuitry for supporting the operation of the monitor device 250, such as described with reference to FIG. 4A.

Still referring to FIG. 2B, the monitor device 250 also preferably includes a monitor media output unit. The monitor media output unit includes a speaker 205 and a video screen 251 for generating an audio and a visual representation of control media data received by the receiver 213 from the master control device 300 or monitor media data received from other monitor devices within the system.

Referring now to both FIGS. 2A-B, the monitor devices 200 and 250, in accordance with further embodiments of the invention include a motion sensor 224. In accordance with this embodiment, the monitor devices 200 and 250 are further configured to control the load circuits based on motion detected by the motion sensor unit 224. The motion sensor unit 224 includes an infrared motion sensor, an ultrasonic motion sensor or a combination thereof. In accordance with this embodiment, the system and the monitor devices 200 and 250 are capable of being placed into a security mode, such that the monitor devices monitor 200 and 250 monitor motion in rooms corresponding to their respective locations. When motion is detected by the motion sensor unit 224, the monitor devices 200 and 250 will automatically collect or record monitor media data and automatically transmit the monitor media data to the master control device 300 (FIGS. 3A-B). The monitor media data can then be played or displayed on the master control device 300 and/or stored in the removable or permanent data storage unit 321 at the master control device 300. Alternatively, or in addition to transmitting the monitor media data to the master control device 300, the monitor devices 200 and 250 are configured to automatically transmit the monitor media data to a remote computer 151 and/or active an external alarm and/or security system 153 (FIG. 1B).

The monitor devices 200 and 250, in accordance with the embodiments of the invention, include a sensor unit. The senor unit includes a temperature sensor 231, a humidity sensor 233, a smoke sensor 237, a gas sensor 235, any other suitable sensor or combination of sensors. The sensors 231, 233, 235 and 237 collect environment data corresponding to the locations of the monitor devices 200 and 250 and periodically transmits the environment data to the master control device 300 (FIG. 3A-B). For example, the sensor unit is a temperature senor 231 and a humidity sensor 233 that monitors weather conditions at the respective locations of the monitor devices 200 and 250. The weather conditions are captured and digitized periodically by an ADC circuit of the monitor devices 200 and 250 and the monitor devices periodically and automatically transmit weather data packets with weather information to the master control device 300, where up-dated representation of the weather data is displayed on an LCD screen 351 at the master control device 300.

As mentioned above, the sensor unit alternatively to, or in addition to, a temperature sensor 231 and a humidity sensor 233 includes a smoke senor 237 or gas sensor 235 for detecting the smoke or a gas leak. Where smoke or a gas is detected by the sensors 237 and 235, the monitoring devices 200 and 250 automatically transmit an alarm signal to the master control device 300 (FIGS. 3A-B) and/or trigger an external alarm system 153 (FIG. 1B).

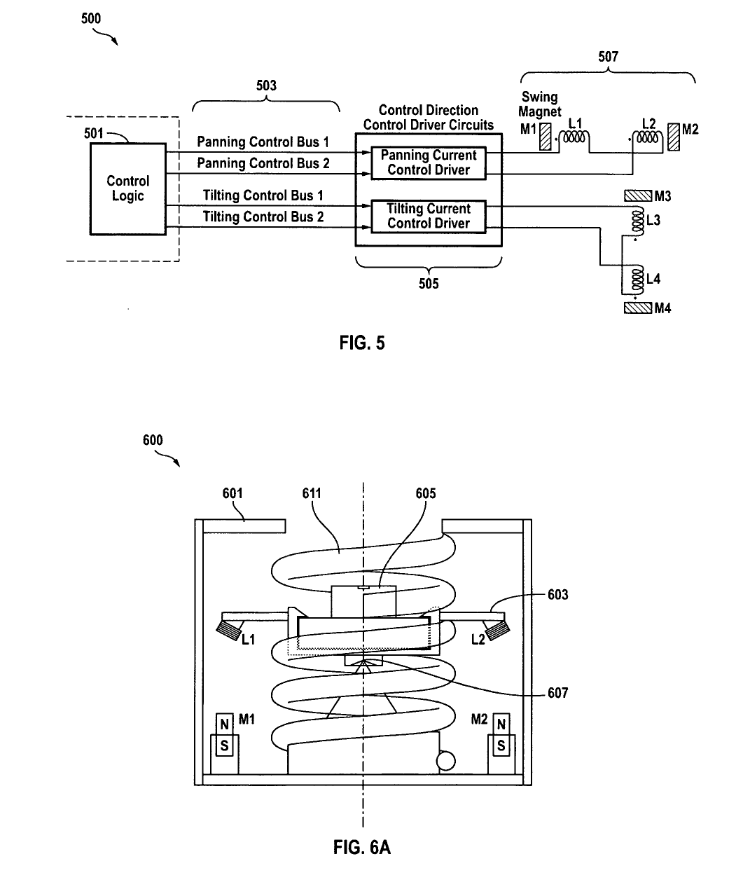

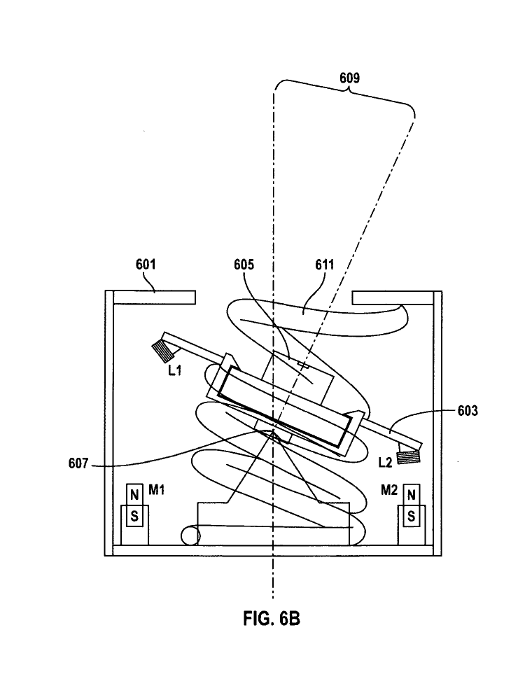

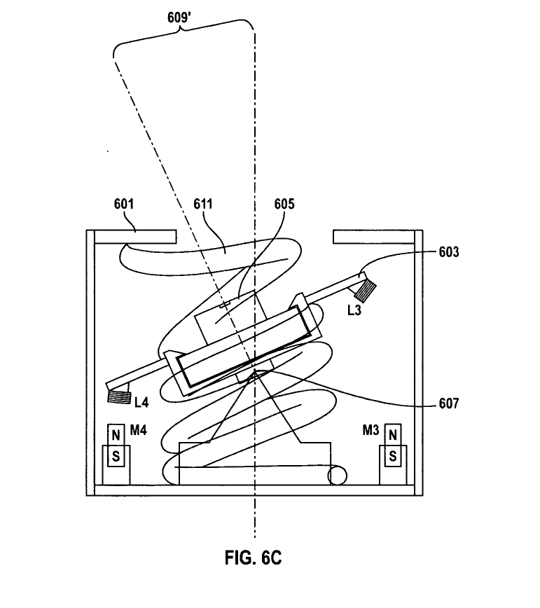

As describe previously, the monitor devices 200 and 250 are preferably powered through the load circuit and/or includes a battery, such as solar cell with rechargeable battery and dry cell or EM field charger circuit with rechargeable battery 218 for providing power. FIG. 2C-D illustrate side views of the monitor device 200 shown in FIG. 2A and the monitoring device 250 shown in FIG. 2B, respectively. As described above, the monitor devices 200 and 250 includes with faceplate bodies 203 and 253. The faceplate body 203 is configured to couple to and fit over a light switch 201 (FIG. 2A) with a momentary switch 209 for manually operating a load circuit. The monitor devices 200 and 250 include the power circuitry 223 which may be a stand alone miniature AC-DC SMPS power module and/or electronic light dimmer switch circuit and AC power wire leads live wire 225 and neutral wire 227 for coupling to the load circuit 228 and providing power to monitor devices 200 and 250. The monitor device 250 also includes a housing structure 251′ for housing the circuitry necessary to operate the video screen 251 (FIG. 2B).

Where the monitoring devices 200 and 250 include a camera unit 219, the camera unit includes is a micro-camera module with and a magnetic motion control mechanism 220 (FIG. 2A-B) for controlling movement of a micro-camera remotely from a master control device 300 through a user interface, such as described in detail below with reference to FIG. 5 and FIGS. 6A-C.

Now referring to FIGS. 3A-B, the system includes a master control device 300 with a housing 303 for housing operable components of the master control device 300, such as described below. The a master control device 300 is preferably a mobile device used to remotely control monitoring devices 200 and 250 (FIGS. 2A-B) for a variety of remote locations. The master control device 300 includes a control media capture unit. The control media capture unit includes microphone 312 and/or a camera 323, such as described above, or any other suitable components for capturing the control media data corresponding to locations of the master control devices within the system. The master control device 300 also includes a control wireless transducer unit with a receiver 311 to receive the monitor media data transmitted from each of the monitor devices within the system. The control wireless transducer unit also includes a transmitter 313 to transmit the control media data from the master controller 300 to each of the monitor devices within the system. The master control device 300 also includes a microprocessor unit 317 programmed with firmware and other circuitry for supporting the operation of the master control device, such as described with reference to FIG. 4B. The master control device 300 in accordance with the embodiments of the invention includes a battery 327 to provide power to the master control device 300 and is preferably configured to dock with a charger (not shown) for recharging the battery 327 for an electrical outlet.

The master control device 300 also preferably includes a control media output unit. The control output unit includes, for example, a speaker 305 and/or a video screen 351 to generate an audio and/or visual representation of the monitor media data transmitted by each of the monitor devices to the master control device 300. In accordance with the embodiments of the invention, the master control device 300 includes a memory unit 321 that includes an internal memory drive and/or a removable memory card, such as a flash card or secured digital memory card.

In accordance with the embodiments of the invention, the master control device 300 is configured to remotely control the load circuits through a plurality of monitor devices. In operation, the master control device 300 can select any of the monitoring devices and play an audio or visual representation of the location corresponding to that of the selected monitor device. The monitor devices are selected from the master control device by entering a code or dialing a number from a user interface, such as described below. Alternatively, the master control device 300 can be configured to play an audio or visual representations of locations from any number of the monitor devices simultaneously.

The monitor devices 200 and 250 (FIGS. 2A-D) and the control device 300 (FIGS. 3A-B) preferably includes a user interface to operate and/or program the monitor devices 200 and 250 and the control device 300. For example, the monitor devices 200 and 250 include a key pad with buttons 215 and/or in the case of the monitor device 250, a video screen 251 that is touch screen. Likewise, the control device includes a key pad with keys 315 and 315′ and/or a video screen 351 that is a touch screen.

FIG. 4A shows a schematic representation 400 of the electrical components of a monitor devices 200 and 250, such as shown in FIGS. 2A-D. The monitor device includes transducer circuitry 401, processing circuitry 403, media data capture/output circuitry 405 and load control circuitry 407. As described above the monitor device is configured to control a load circuit through the load control circuitry 407. The monitor devices 200 and 250 preferably includes a micro-camera module 219 with and a magnetic motion control mechanism 220, such as described in detail with reference to FIG. 5 and FIGS. 6A-C, for controlling movement of a camera unit 219 remotely from a master control device 300 (FIGS. 3A-B) through a user interface, such as described in detail below.

FIG. 4B shows a schematic representation 450 of the electrical components of a master control device 300, such as shown in FIGS. 3A-B. The master control device includes transducer circuitry 451, processing circuitry 453, media data capture/output and command circuitry 455 and memory circuitry 457. As described above the master control device is configured to remotely control the load circuit based on commands input through the media data capture/output and command circuitry 455 as well as the monitor media data acquired through the media data capture/output circuitry 405 of the monitor devices and remotely transmits media data to the master control device.

FIG. 5 shows a schematic representation of the electrical components for a magnetic motion mechanism 500 configured to operate and control a camera 219 of the monitoring devices 200 and 250, described with reference to FIGS. 2A-B. The magnetic motion mechanism 500 includes a driver mechanism 507. The driver mechanism 507 preferably includes a first pair of coils L1 and L2 and a first pair of corresponding magnets M1 and M2 configured to control a panning motion of the camera unit 605 (FIG. 6A-C). The driver mechanism 507 further preferably includes a second pair of coils L3 and L4 and a corresponding second pair of magnets M3 and M4 configured to control a tilting motion of the camera unit 605. The coils L1, L2, L3 and L4 are preferably wire wound coils and the magnets M1, M2, M3 and M4 are preferably Neodymium (Nd—Fe—B) super magnets.

Still referring to FIG. 5, the magnetic motion mechanism 500 includes a control logic 501, which is preferably part of the processing circuitry 403, shown in FIG. 4A. The magnetic motion mechanism 500, further includes panning and tilting driver circuits 505 that execute control signals sent from the control logic 501 to the master control device 300 (FIGS. 3A-B) to the control logic 501 and communicated to the panning and tilting driver circuits 505 through a panning and a tilting control bus 503. A continuous screw tooth current generator (not shown) may also be included in control drive circuits 505 to drive a continuous current through the coils L1, L2, L3 and L4 and thus continuously move the camera unit 605 through pan and tilt angles.

FIGS. 6A-C show cross-sectional side views from the panning and tilting plane of the micro-camera module 600 that is operated using a magnetic motion mechanism 500, such as described above with reference to FIG. 5. As described previously the magnetic motion mechanism 500 is preferably configured to move the micro-camera unit 605 through a range of pan and tilt angles. The micro-camera module 600 includes a housing 601 for holding and housing the operable components of the micro-camera module 600.

The micro-camera module 600 includes a stabilizing spring or coil 611 for urging the camera unit 605 to a central position, such as shown in FIG. 6A, in the absences of an applied driver current. The camera unit 605 is mounted in on a bracket unit 603 with the coils L1, L2, L3 and L4 attached thereto. Preferably, that coils L1 and L2 are positioned at 180 degrees with respect to each other, coils L3 and L4 are posted at 180 degrees with respect to each other and adjacent pairs of coils L1, L2, L3 and L4 are positioned at inclining 45 degrees with respect to each other along the bracket. The bracket 603 also couples the camera unit 605 to the stabilizing spring or coil 611, as shown.

The bracket unit 603 is seated on a pivot structure 607 which allows the that bracket unit 603 and the camera unit 605 to swivel through a range of pan and tilt angles when driver current is applied. In operation, current is driven through the coil pairs generate to generated attractive magnetic forces, repulsive magnetic forces and/or a combination thereof between coil and magnet pairs L1/M1, L2/M2, L3/M3 and L4/M4, thereby causing the bracket unit 603 and camera unit 605 to tilt, pan, rotate or otherwise move. For example, when current is driven through the coil L2 to generate an attractive magnetic force between the coil/magnet pair L2/M2 and current is driven through the coil L1 to generate a repulsive magnetic force between the coil/magnet pair L1/M1 pair, the camera unit 605 moves through a panning angle 609, such as shown FIG. 6B. Similarly, when current is driven through the coil L4 to generate an attractive magnetic force between the coil/magnet pair L4/M4 and current in driven through the coil L3 to generate a repulsive magnetic force between the coil/magnet pair L3/M3 pair, the camera unit 605 moves through a tilting angle 609′, such as shown FIG. 6C. It will be clear to one skilled in the art from the discussions above that the magnetic motion mechanism 500 (FIG. 5) and micro-camera module 600 of the present invention can include any number of coil/magnet pair arrangements and can be configured to operated using any number of driver current sequences or patterns to move the bracket unit 603 and the camera unit 605 through a range of different angles and motions. For example, as mentioned above control driver circuit can include a Screw Tooth Waveform Current Generator or continues step pulse current generator, which modulates the current generation, causing the bracket unit 603 and the camera unit 605 continuously move through negative and positive pan or tilt angles. When the driver circuit stops to supplying current to the coils L1, L2, L3 and/or L 4, the stabilizing spring or coil 611 urges the bracket unit 603 and camera unit 605 to return to the initial position corresponding to a zero pan and zero tilt angle, such as shown in FIG. 6A.

The present invention has been described in terms of specific embodiments incorporating details to facilitate the understanding of principles of construction and operation of the invention. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A system comprising:
a) a monitor device coupled load circuit:
i) a monitor media capture unit configured to capture monitor media data from an area corresponding to a location of the monitor device; and
ii) a monitor wireless transducer unit configured to transmit the monitor media data; and
b) a control device comprising:
i) a control wireless transducer unit configured to receive the monitor media data; and
ii) a control media output unit configured to generate an audio or visual representation of the monitor media data,
wherein the controller device is configured to control the load circuit remotely through the monitor device.

2. The system of claim 1, wherein the monitor device further comprises a motion sensor and wherein the monitor device is further configured to control the load circuit based on motion detected by the motion sensor.

3. The system of claim 1, wherein monitor device further comprises one or more of a temperature sensor, a humidity sensor, a gas sensor and a smoke sensor for collecting environment data corresponding to a location of the monitor device and wherein the monitor device is configured to automatically and periodically transmit the environment data to the control device.

4. The system of claim 1, wherein monitor media capture unit includes one or more of a microphone and a camera.

5. The system of claim 1, wherein control media output unit includes one or more of a speaker and a camera.

6. The system of claim 1, wherein the monitor wireless transducer unit and the control wireless transducer unit are radio wave transducers configured to transmit and receive radio packet data.

7. The system of claim 1, wherein the monitor device includes a faceplate configured to couple to and fit over a momentary switch that manually opens and closes the load circuit.

8. The system of claim 1, wherein the monitor device is configured couple to electrical wall box and control the load circuit manually from the monitor device.

9. The system of claim 1, wherein monitor device includes power circuitry for coupling to the load circuit and providing power to monitor device.

10. The system of claim 1, wherein the monitor device includes user interface selected from the group consisting of key pad and a touch screen, wherein the user interface is configured for operating and programming the monitor device.

11. The system of claim 1, wherein the monitor device further includes a monitor media output unit, the control device includes a control media capture unit and wherein the control media capture unit is configured to capture control media data corresponding to a location of the control device and the control wireless transducer unit is configured to transmit the control media data to the monitor device and the monitor media output unit generates an audio and or visual representation of the control media data.

12. The system of claim 1, wherein the media capture unit includes a micro-camera with a magnetic motion control mechanism for controlling movement of a micro-camera remotely from the control unit.

13. The system of claim 1, wherein the control device includes a user interface selected from the group consisting of key pad and a touch screen, wherein the user interface is configured for remotely operating and programming the monitor device.

14. The system of claim 1, wherein in control device further includes a memory unit for storing the monitor media data or reminder message.

15. A system comprising:
a) a plurality of monitor devices electrically coupled to load circuits, wherein each of the of monitor devices comprise:
i) a monitor media capture unit configured to capture monitor media data corresponding to locations of the monitor devices;
ii) a monitor wireless transducer unit for transmitting the monitor media data and receiving control media data; and
iii) a monitor media output unit to generate an audio and or visual representation of the control media data; and
b) a master control device comprising:
i) a control media capture unit configured to capture the control media data corresponding to a location of the master control device;
ii) a control wireless transducer unit configured to receive the monitor media data transmitted from each of the monitor devices and transmit the control media data; and
iii) a media output unit configured to generate an audio or visual representation of the monitor media data,
wherein the master control device is configured to remotely control the load circuits through the plurality of monitor devices.

16. The system of claim 15, wherein the plurality of monitor devices further comprise a motion sensor for detecting motion in the area corresponding to the location of the plurality of monitor devices, and wherein the plurality monitor devices are further configured control the load circuits based on the motion detected by the motion sensor.

17. The system of claim 15, wherein the motion sensor is selected from the group consisting of an infrared motion sensor and ultrasonic motion sensor.

18. The system of claim 15, wherein monitor media capture unit and the control media capture unit each include one or more of a microphone and a camera.

19. The system of claim 15, wherein monitor media output unit and the control media output unit each include one or more of a speaker and a camera.

20. The system of claim 15, wherein the plurality of monitor devices are configured couple to electrical wall box and are further configured to manually control the load circuits.

21. The system of claim 15, wherein plurality of monitor devices are configured to be powered by the load circuits.

22. The system of claim 15, wherein the plurality of monitor devices are powered by batteries that are recharged using a solar cell and/or 60Hz ac EM field chargers coupled the load circuits.

23. A system comprising a plurality of devices each comprising:
a) a media capture unit configured to capture media data from an area corresponding to locations of the plurality of devices; and
b) a wireless transducer unit and microprocessor unit configured to transmit the media data between each of the plurality of devices in a wireless peer-to-peer network, wherein at least one of the plurality of devices is a hard-wired device configured control a load circuit and wherein at least one of the plurality of devices is configured to remotely control the hard-wired device.

24. The system of claim 23, wherein the media capture unit includes a micro-camera with a magnetic motion control mechanism for controlling movement of a micro-camera remotely from the at least one of the plurality of devices.
